(19) United States
(12) Patent Application Publication
(10) Pub. No.: US 2006/0015639 A1
(43) Pub. Date: Jan. 19, 2006

(54) Method for managing inter-zone bandwidth in a two-way messaging network

(76) Inventor: Benjamin F. Taylor, Chicago, IL (US)

Correspondence Address: MOTOROLA, INC., 1303 EAST ALGONQUIN ROAD, IL01/3RD, SCHAUMBURG, IL, 60196, US

(21) Appl. No.: 10/890,002

(22) Filed: Jul. 13, 2004

(51) Int. Cl. G06F 15/16

(52) U.S. Cl. 709/235

(57) ABSTRACT

A congestion control level method for a messaging system having a plurality of exit routers (104) coupled to a plurality of zone controllers (102) which includes determining a congestion control value based on the traffic type, and notifying the plurality of zone controllers over the control plane of the congestion control level on the audio plane based on the congestion control value. The traffic type can be audio, voice and/or data as described herein.

### FIELD OF THE INVENTION

This invention relates to a method for managing bandwidth within a number of zones, each zone formed to include one or more transmitter units and more particularly, to such a method for handling bandwidth efficiently and reliably on inter-zone links in order to minimize congestion.

### BACKGROUND OF THE INVENTION

Bandwidth is a precious commodity in today's marketplace, thus there have been significant efforts to optimize bandwidth utilization in all areas of network communication.

The problem lies in the independence of the network topology from the application which is inherent in internet technology. In the past implementations of transmission control protocol (TCP) which is well known in the art, congestion control is accomplished by adjusting a congestion control window based on the number of dropped packets. Adjusting the congestion control window based on the number of dropped packets is both inefficient and inaccurate, since it relies on the assumption that congestion is the only significant contributor to dropped packets and requires that packets be dropped even though they could have been successfully delivered.

In two-way messaging systems, simply adjusting the congestion control window based on the number of dropped packets is absolutely unacceptable, as it results in audio/voice calls (e.g., packets, traffic) being dropped needlessly. Instead, the zone controllers, which function as the brains of the two-way radio system, are responsible for assigning resources in and across zones (e.g. over an inter-zone link).

In such systems, there is also a significant probability for extremely large call volumes to traverse the inter-zone links, though the average utilization may be smaller by orders of magnitude. Even though the application layer has no direct knowledge of the inter-zone network topology, it is necessary that the application act in a manner such that these bursty conditions are properly handled should they occur. If an inter-zone link is ever congested or over-subscribed for a significant period of time, all calls on the link will experience added delay and jitter such that no call traversing the link will be intelligible at the other end.

Therefore, what is needed is a messaging method for handling inter-zone bandwidth efficiently and reliably in order to minimize the amount of bandwidth required, while at the same time providing acceptable levels of jitter and delay. Ideally the method will detect impending congestion problems before they occur and dynamically handle congestion on the inter-zone links through busying/rejecting incoming call request.

### BRIEF DESCRIPTION OF THE FIGURES

A preferred embodiment of the invention is now described, by way of example only, with reference to the accompanying figures in which:

FIG. 1 (prior art) illustrates a two-way messaging system utilizing an IP network topology having a plurality of zone controllers, a plurality of exit routers, and parallel control plane and audio plane communications paths;

FIG. 2 (prior art) illustrates a type of service (TOS) field of an IP packet header;

FIG. 3 is a flow chart illustrating an algorithm implemented by a zone controller used to detect the congestion control level in accordance with the preferred embodiment of the present invention;

FIG. 4 is a flow chart illustrating a link algorithm implemented by an exit router used to detect the congestion control level on a inter-zone link in accordance with the preferred embodiment of the present invention; and

FIG. 5 is a flow chart illustrating a packet algorithm implemented by an exit router used to notify a zone controller of a congestion control value in accordance with the preferred embodiment of the present invention.

### DETAILED DESCRIPTION OF THE PREFERRED EMBODIMENT

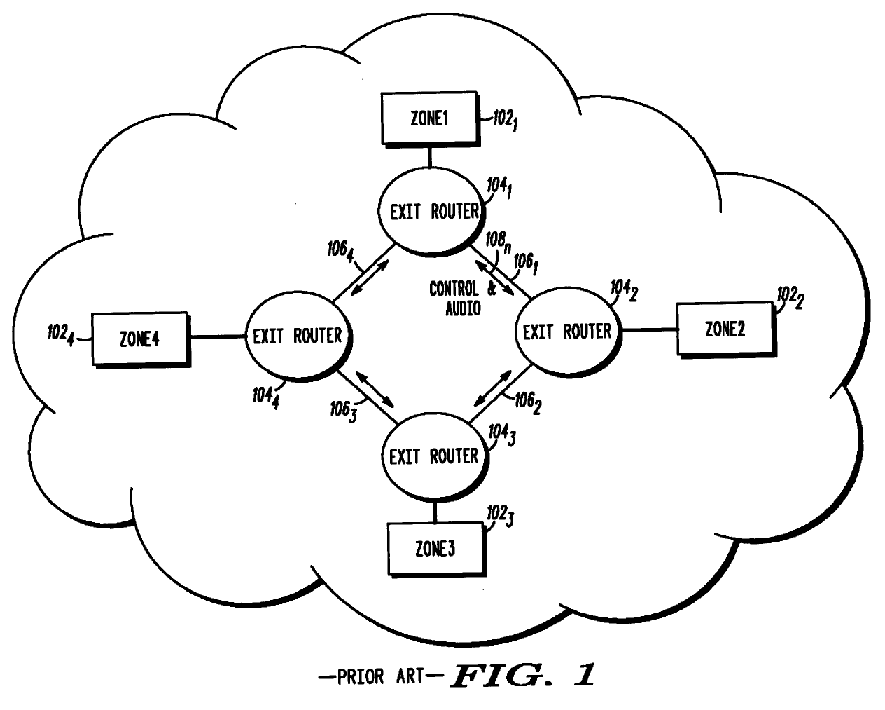

The present invention discloses a method for handling bandwidth efficiently and reliably on inter-zone links in order to minimize congestion in a two-way messaging system having a plurality of zone controllers and exit routers that use the same control plane and audio plane communications paths. The present invention discloses a method that determines a congestion control value (e.g., an explicit congestion notification (ECN) value) of a particular link based on the traffic type, and notifies at least a subset of the plurality of zone controllers over the control plane of the congestion control level of the link based on the congestion control value perceived on the audio plane. The present invention also discloses a method that assesses the availability of inter-zone resources by processing the congestion feedback information received by the zone controllers as indicated by the exit routers. Let us now refer to FIGS. 1-5 to describe the present invention in greater detail. It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

A two-way messaging system as shown in FIG. 1 illustrates a plurality of zone controllers 102 and a plurality of exit routers 104. Each zone controller 102 is coupled to an exit router 104, and the exit routers 104 are coupled to each other via inter-zone links 106 in a two-way messaging system in an IP network topology 100 as known in the art. In the IP network topology 100, each zone controller 102 can be thought of as a node, connected to other zone controllers 102 through a partial mesh. The inter-zone links 106 typically have enough bandwidth to support a predetermined number of calls. Each zone controller 102 in the IP network views its collective inter-zone traffic to and/or from any other zone in a framework similar to that employed by a single TCP session between two hosts.

Historically, control traffic between zones used separate links from those used for audio traffic. The network of physical connections used for control traffic was referred to as the control plane, and the network used for audio traffic was referred to as the audio plane. As shown in FIG. 1, in IP based two way messaging systems, control traffic and audio traffic streams are packetized and interleaved and thus can share the same physical links 108. However, the concept of a control plane and an audio plane is still employed for the purpose of illustration, even though the two logical planes both share the same physical medium. Therefore each zone controller 102 has a corresponding control and audio plane that flows over the same inter-zone link 106. This allows the system to ensure that traffic is not sent while the control and audio paths 108 are unavailable due to re-convergence during a link failure.

The packetized traffic is based on different traffic types (e.g., audio/voice packets, data packets) which are prioritized based on the precedence bits in the TOS byte 200 of the IP packet header in a manner which is known to those skilled in the art. Once the packets arrive at the destination zone, they are sent to the appropriate end node(s) (e.g., audio flows down to the end nodes and the control traffic flows down to the zone controllers).

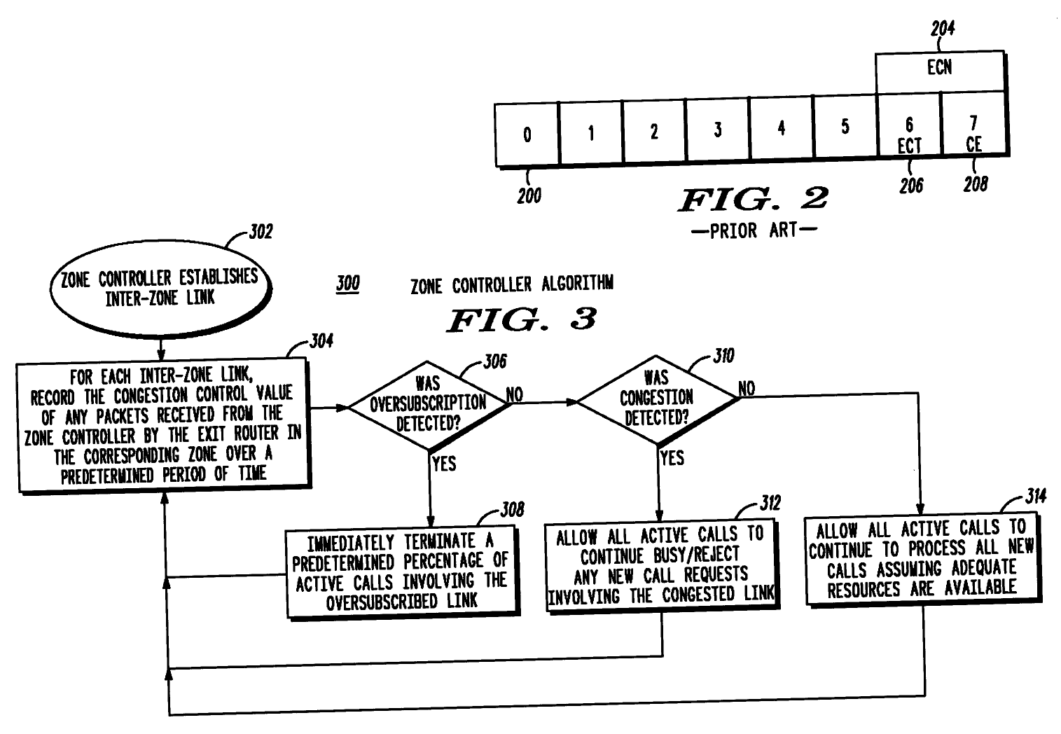

In the present invention, using the congestion control level as described below in FIG. 2, any incoming/inbound or outgoing/outbound packet traversing a congested link results in the packet being marked with an congestion control value, and the marking is conveyed to the end node (e.g., user device; not shown) located in the zone of transmitting zone controller 102. Thus, if the voice traffic exceeds a congestion control level on any inter-zone link 106, the exit router 104ₙ sets the appropriate congestion control value.

FIG. 2 illustrates the type of service (TOS) byte 200 of the IP packet header. The TOS byte 200 of the IP packet header comprises eight bits (bits 0-7) and is currently defined in the Internet Engineering Task Force (IETF) standard RFC 3168. The combination of bits 6 and 7 of the TOS byte 200 is known in the art as an ECN field 204. The congestion control value located in the ECN field 204 is used to explicitly provide congestion information to the zone controller. In the IETF standard RFC 3168, ECN-Capable Transport (ECT) bit (e.g., Bit 6) 206 allows the exit routers to determine whether or not end nodes are capable of Layer 3 congestion control and the congestion experienced (CE) bit (e.g., Bit 7) 208 is used to provide a mechanism for the exit routers to signal congestion to end node without dropping packets.

In the present invention, the congestion control value in the ECN field 204 has four settings which represent the congestion level: 01 for congestion, 10 for no congestion, 11 for oversubscription, and 00 for non-ECN capable transport.

The exit router 104 sets the congestion control value to 01 to indicate congestion when the number of calls on a link increases to a point where audio may begin to experience enough delay to affect audio quality. This can occur under normal system operation. The congestion threshold should be determined to be the % utilization (or bytes of audio per sampling interval) at which the queuing delay of audio packets is at the limit of what is considered acceptable. When this limit is exceeded, no new calls are allowed to begin, but existing calls can continue. However, oversubscription is a higher % utilization than what is used for congestion. It is not expected to occur under normal system operation. It can occur when a link failure causes a large number of calls to be re-routed or when an unusually large number of calls begin within a very small period of time. At this point, all audio is severely affected and some immediate action must be taken to reduce the number of calls traversing the oversubscribed link, thus the exit router 104 sets the congestion level to 11. The exit router 104 sets the congestion level to 00 for non-ECN capable transports as an indication that the end nodes are not capable of detecting layer 3 congestion control as defined IETF standard (e.g., ECT bit 206).

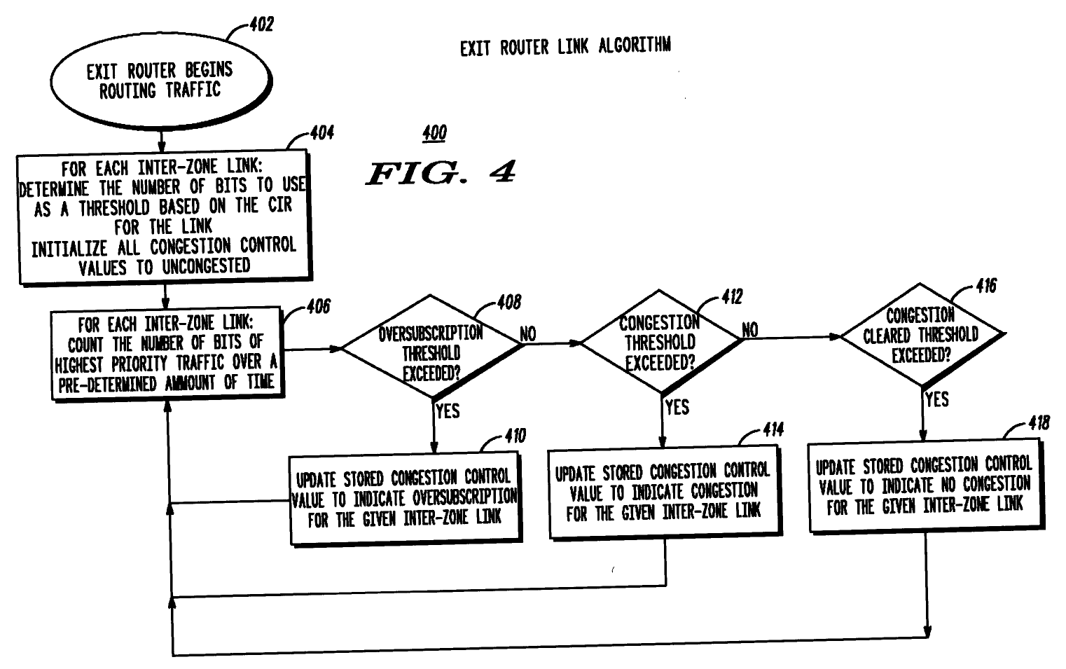

Thus, the addition of the ECN field 204 in the IP packet header 200 is used in the present invention to implement a closed-looped feedback control algorithm in the zone controllers 102 as further described in FIG. 3. The zone controllers 102 and exit routers 104 are viewed as components in the closed-loop feedback system, with each having the capability of controlling an output signal based on feedback from the network. The zone controllers 102 use the requested call loading along with the received congestion control value in the ECN field 204 to adjust the amount of traffic allowed on the network. The exit routers 104 use the amount of traffic it perceives to adjust the congestion control value in the ECN field 204 before it is sent to the zone controller 102.

FIG. 3 illustrates a flow chart 300 of an algorithm implemented by each zone controller 102 in the IP network. As illustrated, the zone controller 102 establishes all inter-zone link 106 throughout the network (at step 302), by transmitting a control packet with the congestion control level set to 01 to indicate no congestion as previously described in FIG. 2. After which, for each of inter-zone links 106, the zone controller 102 records the congestion control value of any incoming packets received from another zone over a predetermined period of time (e.g., 0-10 seconds; at step 304). The zone controller 102 then determines if an oversubscription is detected on one of inter-zone links (at step 306). If the zone controller 102 detects an oversubscription of any of inter-zone links (at step 306), the zone controller 102 immediately terminates a predetermined percentage (e.g., 10%-50%) of active calls involving the oversubscribed inter-zone link(s) (at step 308). If the zone controller 102, however, does not detect an oversubscription of any of the inter-zone links (at step 306), the zone controller 102 determines if there is any congestion detected on any the inter-zone links 106 (at step 310). If the zone controller 102 detects congestion, the zone controller 102 allows all active calls to continue and busy/reject (i.e., deny) any new call requests involving the congested inter-zone link (at step 312). If the zone controller 102, however, does not detect congestion on any of its inter-zone links (at step 310), the zone controller 102 allows all active calls to continue and processes all new call requests accordingly (at step 314), assuming all other necessary resources are available.

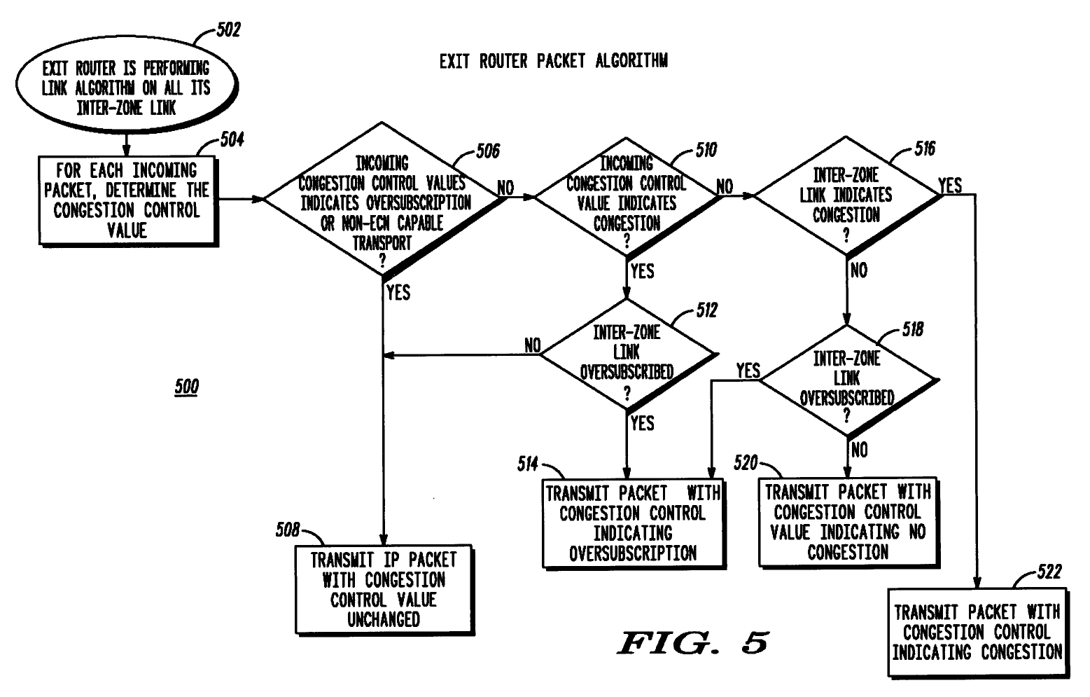

Referring back to FIG. 1, the control and audio paths are bidirectional in nature, such that audio from one zone controller 102 to another zone controller 102 does not necessarily follow the same path as the audio in the other direction. As such, it is possible for two zone controllers 102 to arrive at different estimates of the inter-zone bandwidth available for audio traffic between the two zones. For example, it is possible for congestion/oversubscription to be detected from Zone4 102₄ to Zone2 102₂, when there is no congestion/oversubscription detected on the reverse path from Zone2 102₂ to Zone4 102₄. In this scenario, the algorithm implemented by the zone controller 102 has to provide a mechanism for the zone controllers 102 to know the congestion control value in both zones and use the worse value of the two. Having the zone controllers 102 aware of the perceived congestion of other zones is accomplished by having all zone controllers 102 involved to determine their ability to participate in a call based on the congestion control value that it receives from the exit routers 104 as further described in FIG. 5. Thus, the inter-zone traffic resources are restricted appropriately whenever any congestion/oversubscription is experienced in the traffic flow between two zones (e.g., a call between Zone2 102₂ and Zone4 102₄ is busied/rejected if congestion is detected in either zone).

As previously noted in FIG. 2, the congestion control value is set by the exit routers 104 whenever the congestion control level is exceeded. Setting the congestion control value to the appropriate level provides a positive indication to the end nodes located in the various zones whenever congestion/oversubscription is experienced in the network by the traffic between the two zones, regardless of the location of the congestion. The positive indication of congestion/oversubscription in the network allows the end nodes to adjust their traffic flow rates appropriately without any direct knowledge of the network topology or inter-zone link speeds.

FIG. 4 is a flow chart illustrating a link algorithm implemented by each exit routers 104 for detecting the congestion control level on an inter-zone link. As illustrated, an exit router 104 begins routing traffic to the inter-zone links 106 (at step 402). For each of its inter-zone links, the exit router 104 determines a threshold based on the physical link speed or the committed information rate (CIR) for the connection and initializes all congestion control values to uncongested for each of its inter-zone links 106. The threshold for each of the inter-zone links is preferably established independently and is set as a percentage of the available physical bandwidth.

For each inter-zone link, each exit router 104 counts the number of bits of the highest priority traffic over a predetermined amount of time (e.g., 60 msec-10 sec), (at step 406). It will be appreciated by those skilled in the art that the highest priority traffic is typically, but not always, audio/voice traffic. If an exit router 104 determines that the oversubscription threshold (e.g., 70-100% of the CIR) is exceeded (at step 408), the exit router 104 updates the stored congestion control value to indicate the oversubscription for the appropriate inter-zone link (at step 410) and loops back through the algorithm (starting at step 406). If no oversubscription is detected (at step 412), the exit router 104 determines if the congestion threshold (e.g., 40-90% of the CIR) has been exceeded. If the exit router 104 has determined that the congestion threshold has been exceeded, the exit router 104 updates the stored congestion control value to indicate congestion for the appropriate inter-zone link 106 (at step 414) and loops back through the algorithm (starting at step 406). If the congestion threshold is not exceeded, the exit router 104 checks to see if the congestion cleared threshold (0-50%) has been exceeded (at step 416), if the congestion clear threshold has not been exceed, the exit router 104 updates the congestion control value to indicate that there is no congestion for the appropriate inter-zone link 106 (at step 418) and loops back through the algorithm (starting at step 406).

By way of example, if the CIR is set to 4 Mbps, which is equivalent to 500,000 bytes per second and the sampling frequency of the exit router link algorithm is 500 msec. 100% would then be 250,000 bytes of traffic for the given interval. If the oversubscription threshold is 85%, the congestion threshold would be 70%, and the congestion cleared threshold would be 50%, that would correspond to 212,500 bytes, 175,000 bytes, and 125,000 bytes, respectively. So the exit router link algorithm would count bytes of voice traffic sent on a given outgoing link for 500 msec. The algorithm then sets the congestion control value used by the exit router packet algorithm for the next 500 msec depending on where this value falls relative to the calculated thresholds. At the end of the next 500 msec, the number of bytes in that interval is measured again, and the congestion control value is updated.

FIG. 5 is a flow chart illustrating a packet algorithm implemented by each exit router 104. The packet algorithm is used by the exit routers 104 to notify (e.g., transmitting) and update the zone controllers 102 of the congestion control value. By adapting the congestion feedback information (which indicates the number of available inter-zone link resources used to determine the congestion window size) received from the zone controllers 102, the exit routers 104 are able to continually update the congestion control threshold.

As illustrated in FIG. 5, the exit router 104 performs the link algorithm as described in FIG. 4 on all of its inter-zone links 106 (step 502). For each incoming packet, the exit router 104 determines the congestion control value of the inbound packet based on the congestion control value (at step 504). If the congestion control value of the incoming packet(s) indicates an oversubscription (at step 506), the exit router 104 transmits the packet to the appropriate zone controller 102 with the congestion control value unchanged (at step 508). If the congestion control value of the incoming packet, however, does not indicate an oversubscription (at step 506), the exit router 104 determines whether the congestion control value indicates congestion (at step 510).

If the congestion control value of the incoming packet(s) arrive indicating congestion (at step 510), and the exit router 104 determines that there is an oversubscription on the inter-zone link 106 (at step 512), then the exit router 104 transmits the packet(s) with the congestion control value indicating an oversubscription (at step 514). If the inter-zone link 106 is not oversubscribed, the exit router 104 transmits the packet(s) with the congestion control value unchanged (loop back to step 508). If a packet arrives either indicating there is no congestion (at step 516), but the exit router link algorithm has determined oversubscription to be present on the inter-zone link 106 (at step 518), the exit router 104 transmits the packet with the congestion control value indicating oversubscription (loop back to step 514). If the exit router 104, however, determines that there is no oversubscription or congestion, it transmits the packet(s) indicating no congestion (at step 520). If the inter-zone link 106 is congested (at step 516), the exit router 104 transmits the packet(s) with the congestion control value indicating that there is congestion (at step 522). Thus there are three possible congestions levels in order of increasing severity: uncongested, congested, over-subscribed. The exit router 104 transmits outbound packets indicating the worst of the detected congestion levels either based on the exit router algorithm or the incoming congestion control value in the packet. If the fourth value, non-ECN capable transport (00) is detected, it is allowed to pass through the network unchanged.

It will be appreciated by those skilled in the art that there are alternative devices, individually or in combination, which can provide the functionality of the algorithms 300, 400, 500 other than the zone controllers 102 and the exit routers 104, as described above including but not limited to bandwidth management devices that would sit between the exit router 104 and a wide area network switch passing traffic through. The primary purpose of the bandwidth management devices would be to determine the congestion control value in the TOS byte 200 and notify the zone controllers 102 of its congestion control level via the appropriate inter-zone link, so that the zone controllers 102 can determine the available inter-zone resources (e.g., bandwidth resources).

It will also be appreciated by those skilled in the art that the power of two-way messaging systems lies in the scalability and wide use of “off-the-shelf” products. This inherently adds a requirement that the zone controller need not have knowledge of the underlying network topology.

Therefore, in order for any method of reduction in the inter-zone bandwidth requirements to be feasible, it must be shown that oversubscription of the inter-zone links is either impossible or highly improbable with sufficiently mitigated impact, thus allowing all zone controllers in the system to effectively and efficiently manage inter-zone resources.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

We claim:

1. A method for controlling congestion in a messaging system having a plurality of exit routers coupled to a plurality of zone controllers via inter-zone links, the method comprising the steps of:
determining a congestion control value based on a traffic type; and
notifying at least one zone controller over a control plane of the congestion control level on an audio plane based on the congestion control value.

2. The method of claim 1 wherein the steps of determining the congestion control value, further comprises the steps of:
counting a predetermine number of bits based on the traffic type over a predetermined period of time;
determining if a predetermine threshold has been exceeded with the predetermined period of time; and
updating the congestion control value based the predetermined threshold.

3. The method of claim 1 wherein the step of notifying the at least one zone controller over the control plane of the congestion level on the audio plane further comprises the step of the at least one zone controller detecting if the inter-zone links is congested.

4. The method of claim 3 wherein the step of detecting if the inter-zone link is congested, further comprises the step of the at least one zone controller denying access to a predetermined number of user devices.

5. The method of claim 1 wherein the step of notifying the at least one zone controller over the control plane of the congestion level on the audio plane further comprises the step of the at least one zone controller detecting if the inter-zone links is not congested.

6. The method of claim 5 wherein the step of detecting if the inter-zone link is uncongested, further comprises the step of the at least one zone controller allowing access to a predetermined number of user devices.

7. The method of claim 1 wherein the step of notifying the at least one zone controller over the control plane of the congestion level on the audio plane further comprises the step of the at least one zone controller detecting if the inter-zone links is oversubscribed.

8. The method of claim 7 wherein the step of detecting if the inter-zone link is oversubscribed, further comprises the step of the at least one zone controller:
determining if an inter-zone link resource is available;
allowing a predetermined number of users to acquire the inter-zone link resource; and
denying access to at least one of the predetermined users when no inter-zone link resource is available.

9. The method of claim 8 wherein the predetermined number of users is updated automatically based on a predetermined number of call loading requests of the inter-zone links between at least a first zone controller and a second zone controller.

10. The method of claim 1 wherein the traffic type is based on audio.

11. The method of claim 1 wherein the traffic type is based on data.

12. The method of claim 1 wherein the traffic type is based on voice.

13. A congestion control level method for a messaging system having a bandwidth management device coupled to a plurality of zone controllers via inter-zone links, the method comprising the steps of:
determining a congestion control value based on a traffic type; and
notifying at least one zone controller over a control plane of the congestion control level on an audio plane based on the congestion control value.

14. The method of claim 13 wherein the step of notifying the at least one zone controller of the congestion control level further comprises the step of notifying the inter-zone link over the control plane that there is the oversubscription on the audio plane.

15. The method of claim 13 wherein the step of notifying the at least one zone controller of the congestion control level further comprises the step of notifying the inter-zone link over the control plane that there is congestion on the audio plane.

16. The method of claim 13 wherein the step of notifying the at least one zone controller of the congestion control level further comprises the step of notifying the inter-zone link over the control plane that there is no congestion on the audio plane.

17. A congestion control level method for a messaging system having a plurality of zone controllers, the method comprising the steps of a zone controller:
receiving a congestion control value; and
determining the congestion control level based on the congestion control value.

18. The method of claim 17 wherein the step of receiving the congestion control value further comprises determining the state of an inter-zone link.

19. The method of claim 18 wherein the step of determining the state of the inter-zone link comprises the step of a zone controller detecting if the inter-zone link is congested.

20. The method of claim 18 wherein the step of determining the state of the inter-zone link comprises the step of a zone controller detecting if the inter-zone link is uncongested.

21. The method of claim 18 wherein the step of determining the state of the inter-zone link comprises the step of a zone controller detecting if the inter-zone link is oversubscribed.

22. A control congestion level method for a messaging system having zone controllers coupled to exit routers and utilizing inter-zone link resources for communication, the method comprising the steps of:
assessing a number of available inter-zone link resources to determine a congestion control level; and
processing the congestion control level based on feedback information received by at least one zone controller.

23. The method of claim 22 wherein the step of processing the congestion level further comprises the step of receiving a congestion control value transmitted by at least one exit router.
